(19) United States
(12) Patent Application Publication
(10) Pub. No.: US 2014/0280589 A1
(43) Pub. Date: Sep. 18, 2014

(54) METHOD AND SYSTEM FOR MUSIC COLLABORATION

(71) Applicant: Damian Atkinson, Jersey City, NJ (US)

(72) Inventor: Damian Atkinson, Jersey City, NJ (US)

(21) Appl. No.: 14/204,484

(22) Filed: Mar. 11, 2014

Related U.S. Application Data
(60) Provisional application No. 61/777,326, filed on Mar. 12, 2013.

(51) Int. Cl. H04L 29/06

(52) U.S. Cl. CPC H04L 65/403
USPC 709/204

(57) ABSTRACT

Disclosed is a system and method for providing at least one music collaboration software module to a first user and a second user. The at least one music collaboration software module provided to the first user is configured to work in conjunction with a first recording software module, and the at least one music collaboration software module provided to the second user is configured to work in conjunction with a second recording software module. The music collaboration software module is configured to enable the first user to collaborate in real time with the second user over the network. In one embodiment, the first recording software module is different from the second recording software module. In another embodiment, the music collaboration software enables streaming of music between the first computing device and the second computing device.

### CROSS REFERENCE TO RELATED APPLICATIONS

This patent application claims the benefit of U.S. Provisional Patent Application Ser. No. 61/777,326, titled “Method and System for Music Collaboration” filed on Mar. 12, 2013, the contents of which are incorporated herein by reference.

### FIELD

The present disclosure relates to music collaboration, and more specifically to systems and methods for enabling music collaboration.

### BACKGROUND

Recording media such as music is often a time-intensive, labor-intensive, and budget-intensive process. Different parties associated with the music, such as a vocalist, guitarist, drummer, engineer, and/or producer, often travel to a studio to record the media. The studio may be very far from one or more of the parties, thereby increasing the time and costs of the party traveling to the studio. Further, having each party travel to the studio is usually very expensive for the producer if he/she has to pay for everyone to travel. Even if each party pays for his own traveling, the costs can add up quickly.

Additionally, it is often difficult to coordinate the recording of the media with everyone's schedules. Each suggested date for the recording may not be available for all of the parties. For example, the vocalist or singer may be touring with his or her band during a first time period, while the guitarist may be in a remote location during a second time period. Thus, neither the vocalist nor the guitarist may be able to travel to the studio during this first or second time period, thereby postponing the recording or production of the media.

The arrival of the home studio has decreased the need for central media studios. Music recording software, such as Pro Tools® software developed by Avid Technology, Inc. of Burlington, Mass., can be used by an individual to record, edit, and/or produce music. Nonetheless, problems exist with home studios. For example, if a vocalist is using his or her home studio, and the home studio is utilizing a music recording software of certain type (e.g., Pro Tools® software), then the vocalist can only communicate his or her recorded tracks with someone else who also has the same recording software. If the guitarist does not have the same recording software, then the guitarist or vocalist may have to travel to the other's home studio, and the above problems exist. Further, even if different parties are using the same music recording software, the parties are forced to communicate tracks via email. This clumsy approach eliminates people working together, obtaining feedback from others in the group in real-time, and feeding off of the energy or excitement of the group. Additionally, if something needs to be changed in a track, the person has to redo the track and again send the track to the other party via email. Thus, the creation of music via a home studio often requires a significant time investment and a party is typically not surrounded by others in the group.

### SUMMARY

The present disclosure relates to a music collaboration software module that enables users to collaborate in real time over a network such as the Internet when creating a music recording. In one aspect, a method and computing system provides at least one music collaboration software module to a first user and a second user. The at least one music collaboration software module provided to the first user is configured to work in conjunction with a first recording software module, and the at least one music collaboration software module provided to the second user is configured to work in conjunction with a second recording software module. The music collaboration software module is configured to enable the first user to collaborate in real time with the second user over the network. In one embodiment, the first recording software module is different from the second recording software module. In another embodiment, the music collaboration software enables streaming of music between the first computing device and the second computing device.

In one embodiment, the at least one music collaboration software module can be downloaded by the first user and/or the second user. The at least one music collaboration software module enables the first user to record a first track using the first recording software module and enables the second user to record a second track using the second recording software module. In one embodiment, the at least one music collaboration software module merges the first track and the second track into a single music recording.

In one embodiment, the at least one music collaboration software module establishes communications between the first user and the second user via a social networking platform or an instant messaging service. The first user and/or the second user can upload and/or download music tracks to/from the cloud.

In one embodiment, the music collaboration software module is configured to enable the first user to collaborate in real time with the second user via one or more of voice, video, and streaming. The first user can also be displayed a choice of to what the first user will be alerted.

These and other aspects and embodiments will be apparent to those of ordinary skill in the art by reference to the following detailed description and the accompanying drawings.

### BRIEF DESCRIPTION OF THE DRAWINGS

In the drawing figures, which are not to scale, and where like reference numerals indicate like elements throughout the several views:

FIG. 1A is a block diagram illustrating devices for allowing users to obtain a music collaboration software module in accordance with an embodiment of the present invention;

FIG. 1B is a flowchart of exemplary steps performed by a first user operating a first client device and a second user operating a second client device in accordance with an embodiment of the present invention;

FIG. 2A is a flow diagram of the client devices communicating with music collaboration software in accordance with an embodiment of the present invention;

FIG. 2B is a Venn diagram showing the relationship between the music collaboration software, a home studio, a user, and a social aspect in accordance with an embodiment of the present invention;

FIG. 3 is a flowchart illustrating steps performed by the first client device in accordance with an embodiment of the present invention;

FIG. 4 is a flowchart illustrating steps performed by the second client device in accordance with an embodiment of the present invention;

FIG. 5 is a flowchart illustrating steps performed by the music collaboration software in accordance with an embodiment of the present invention;

FIG. 6 is a block diagram of components of a client device in accordance with an embodiment of the present invention; and

FIG. 7 is a block diagram illustrating an internal architecture of a computer in accordance with an embodiment of the present invention.

### DESCRIPTION OF EMBODIMENTS

Embodiments are now discussed in more detail referring to the drawings that accompany the present application. In the accompanying drawings, like and/or corresponding elements are referred to by like reference numbers.

Various embodiments are disclosed herein; however, it is to be understood that the disclosed embodiments are merely illustrative of the disclosure that can be embodied in various forms. In addition, each of the examples given in connection with the various embodiments is intended to be illustrative, and not restrictive. Further, the figures are not necessarily to scale, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; exemplary embodiments are provided merely to be illustrative. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

The present disclosure is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the invention. The disclosed methods are not limited to the operations and logical flow presented herein. Alternative embodiments are contemplated in which the order of the various operations is altered and in which sub-operations described as being part of a larger operation are performed independently.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

FIG. 1A is a block diagram illustrating an exemplary embodiment of a network and devices implementing embodiments of the present invention. Other embodiments that may vary, for example, in terms of arrangement or in terms of type of components, are also intended to be included within the scope of the invention. FIG. 1A includes, for example, a first client device 105 in communication with a server 110 over a wireless network 115 connected to a local area network (LAN) and/or wide area network (WAN) 120, such as the Internet. Similarly, a second client device 125 is in communication with the server 110 over the wireless network 115 connected to the LAN/WAN 120. Although shown as a wireless network 115 and WAN/LAN 120, the first client device 105 and the second client device 125 can communicate with the server 110 via any type of network or via separate networks. Further, in one embodiment, the first client device 105 is in communication with the second client device 125 via a network.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows® Server, Mac® OS X®, Unix®, Linux®, FreeBSD®, or the like.

Server 110 may include a device that includes a configuration to provide content via a network to another device. A server 110 may, for example, host a site, such as Yahoo!®'s web site. A server 110 may also host a variety of other sites, including, but not limited to, business sites, social networking sites, educational sites, dictionary sites, encyclopedia sites, wikis, financial sites, government sites, personal sites, etc.

Server 110 may further provide a variety of services that include, but are not limited to, web services, third-party services, audio services, video services, email services, instant messaging (IM) services, SMS services, MMS services, FTP services, voice over IP (VOIP) services, calendaring services, photo services, a cloud, or the like. Examples of content may include text, images, audio, video, or the like, which may be processed in the form of physical signals, such as electrical signals, for example, or may be stored in memory, as physical states, for example. Examples of devices that may operate as a server include desktop computers, multiprocessor systems, microprocessor-type or programmable consumer electronics, etc.

In one embodiment, the server 110 hosts or is in communication with a database 130. The database 130 may be stored locally or remotely from the server 110.

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

In one embodiment and as described herein, one or both of the client devices 105, 125 are smartphones. In another embodiment, one or both of the client devices 105, 125 are tablets. In another embodiment, one or both of the client devices 105, 125 are computers, laptops, set top boxes, televisions, etc. Further, although shown with two client devices 105, 125, any number of client devices 105, 125 may be present.

The first client device 105 can download, from server 110, an instance 135 of a music collaboration software module. Similarly, the second client device 125 can download an instance 140 of the music collaboration software module. In another embodiment, the server 110 provides access to the music collaboration software module 135, 140 and its functionality via a web page displayed on a browser. In one embodiment, the first client device 105 uses a first music recording software module (e.g., Reason® software developed by Propellerhead Software of Stockholm, Sweden) to record a track of music (e.g., vocals). The second client device 125 can use a second music recording software module (e.g., Pro Tools® software developed by Avid Technology, Inc. of Burlington, Mass.) to record a second track of music (e.g., drums). Unlike conventional music recording, which typically occurs by having each party travel to a central location and then creating their respective tracks, the music collaboration software module 135, 140 enables a first user of the first client device 105 to record a first track using the first client device 105 (e.g., in the comfort of the first user's own home) and enables a second user of the second client device 125 to record a second track using the second client device 125 (e.g., in the comfort of the second user's own home). In one embodiment, the music collaboration software module 135, 140 can then merge the two tracks into a single music recording and store the single music recording (or the separate tracks) at the server 110 or in the cloud (via a cloud service, such as Dropbox® or Box®). In another embodiment, the music recording software can merge the two tracks into a single music recording and the music collaboration software module 135, 140 can store the single music recording (or the separate tracks) at the server 110 or in the cloud. Thus, the music collaboration software module 135, 140 enables users of client devices to collaborate (and establish a communication session between the two devices, as shown with arrow 145), regardless of which music recording software (e.g., Pro Tools®, Reason®, or Logic® developed by Apple Inc. of Cupertino, Calif.) and/or regardless of which operating system the client devices 105, 125 are executing. The communication can involve streaming of the media content, such as streaming audio, video, audio and video, etc. so that the users of the different client devices 105, 125 can collaborate while recording, editing, and/or producing music or media.

The music collaboration software module 135, 140 can enable the users to communicate with each other via the module 135, 140 and/or via a social networking platform such as Facebook®, Twitter®, or an instant messaging service. The communications may be via a wall post (e.g., Facebook® integration) or via a message.

Now referring to FIG. 1B, the first user of the first client device 105 opens a recording application (e.g., Pro Tools®) (Step 150). The first user executes the music collaboration software module 135 (Step 155). The first user then starts a recording session (Step 160). The first user records a first track (e.g., vocals) (Step 165) and uses the music collaboration software 135 to upload the track to the cloud (Step 170). Next, a second user opens a different (or the same) music recording application (e.g., Logic®) (Step 175). The second user executes music collaboration software 140 (Step 180) and creates a second track (e.g., drums) (Step 185). The second user uses the music collaboration software 140 to upload the second track to the cloud (Step 190). In one embodiment, the first user and/or the second user download the tracks from the cloud and use the tracks to create a combination track (e.g., vocals and drums) that combines the first track with the second track (Step 195). Further, the music collaboration software can enable the first user and the second user to communicate (as shown with arrow 145). Therefore, unlike the conventional communication methods currently used, which often includes emailing tracks back and forth between different users in different locations and having a first user redo his track if the second user does not like the first user's track, the music collaboration software enables real-time communications between users located in different locations without requiring email. This real-time communications can be via voice (e.g., VoIP), video (e.g., video conferencing, such as via a web cam), or any other communication means. In one embodiment, the real-time communications can occur via streaming the tracks between the server 110 and the one or more client devices 105, 125.

FIG. 2A is a flow diagram illustrating an embodiment of the flow in relation to the music collaboration software module 135, 140 (shown in FIG. 2A as music collaboration software 205). The first client device 210 can be using a first operating system (e.g., Mac OSX®). The first client device 210 communicates (e.g., a track) with/to the music collaboration software 205. In one embodiment, the first client device 210 and/or the music collaboration software 205 saves this track as a file 215. Further, second client device 220 can be operating a second operating system (e.g., Windows® 7 operating system). The second client device 220 communicates with the music collaboration software 205 and/or the first client device 210 via the music collaboration software 205. The second client device 220 can additionally update or modify file 215. Although shown as a single module, the music collaboration software module 205 can be any number of software modules.

In one embodiment, the music collaboration software 205 uploads the file 215 to a storage, such as to the cloud 225, an external hard drive 230, and/or a backup hard drive 235. The file 215 can then be accessed and/or modified by either or both of the first client device 210 and the second client device 220. The music collaboration software 205 can enable the users of the first client device 210 and the second client device 220 to communicate via video conferencing 230. In one embodiment, the first client device 210 executes a script 235 or plug-in to convert its file(s) (e.g., file 215) to a universal data file that can be imported into any recording application via a script. Similarly, in one embodiment the second client device 220 can execute a script 240 or plug-in to convert its file(s) (e.g., file 215) to a universal data file that can be imported into any recording application via a script.

In one embodiment, the music collaboration software module 205 enables real-time collaboration between multiple users. For example, if a vocalist records a vocal track, the vocalist can use the music collaboration software 205 to upload the track to the cloud. A producer can then listen to the track and provide real-time feedback to the vocalist (e.g., via video). For example, the producer may tell the vocalist that the producer likes the first half of the track but doesn't like the second half. The vocalist can then redo the second half of the track and upload this new track to the cloud. The producer can then listen to this new track and provide further comments. This real-time collaboration occurs without either party traveling, emailing, or logging off of the music collaboration software 205.

FIG. 2B shows a Venn diagram 250 of the music collaboration software's integration into a user's recording of music. The music collaboration software 205 intercepts a user's home studio 255 (e.g., Pro Tools®, Logic®, Reason®, etc.), a user 260 (e.g., producers, vocalist, rappers, bands, engineers, etc.), and a social aspect 265 of the user (e.g., Facebook®, Twitter®, websites, World of Music (WOM)®, banner, print campaign, etc.). The music collaboration software 205 enables users 260 to socially interact via a social aspect 265 (e.g., a social networking site) and via their home studio 255 (e.g., using Pro Tools® software) directly via the music collaboration software 205 without requiring travel or emailing.

FIG. 3 is a flowchart illustrating an embodiment of steps performed in accordance with the invention. The first user opens a recording application (e.g., Pro Tools® software) (Step 305) and starts a recording session (Step 310). The first user finishes recording a first track (e.g., vocals) in the session (Step 315). In one embodiment, the first user continues in the session. In one embodiment, the first user receives a list of selections to which the first user will be alerted, such as sending the track to a user or continuing the session (Step 320). The first client device 105 then determines whether to display a choice for the first user (Step 325). If not, the session continues (Step 330). If so, the selection of the first user is stored (e.g., in the cloud, in a hard drive, in memory, etc.) (Step 335). The first client device 105 then executes the music collaboration software module or script 135 (Step 340) and uploads the track to a cloud server (Step 345). After storing the selection of the first user, the first client device 105 can then proceed to Step 405 of FIG. 4.

Now referring to FIG. 4, in one embodiment, the music collaboration software 135 on the first client device 105 communicates with the music collaboration software 140 on the second client device 125 and sends a list of selections to the second user to which the second user will be alerted (Step 405). The second user can open a recording application (Step 410) and can start recording a session (Step 415). The second user records in his session (Step 420). In one embodiment, after Step 405, the second client device 125 determines whether to display a choice for the second user (Step 425) (e.g., download track to timeline or continue session). If a choice or choices are displayed, the second client device 125 proceeds to Step 505 of FIG. 5. If not, the second client device 125 continues in the session (Step 420).

Referring now to FIG. 5, the music collaboration software 140 reviews files in the cloud to download a track or tracks (Step 505). The music collaboration software 140 downloads the track from the cloud server (Step 510) and the second client device 125 executes a music collaboration software script (Step 515). In one embodiment, the second client device 125 places the track and puts the track in a timeline (Step 520). The second client device 125 then proceeds to Step 420 of FIG. 4, where it continues the recording session.

In one embodiment, when a user signs up to the music collaboration software, the user's contacts are imported into the music collaboration software. Next, the user's assets (e.g., musical tracks), if already created, are imported. The user can select the recording software, can choose a record label, what artists this session is for, if this is for an album or song, etc. In one embodiment, every file imported into the music collaboration software is translated from the underlying recording software (e.g., Pro Tools®) to a format that is readable and accessible by the music collaboration software and, in one embodiment, different types of recording software. For example, the music collaboration software can save a track as the highest quality audio file (e.g., a WAV file or an AIF file). On playback, the music collaboration software may stream the audio to the first client device 105 and the second client device 125 via the cloud.

The music collaboration software is a secondary application to use with the currently available recording software and future releases of recording software. The music collaboration software can be used with any recording software used by any number of users without the requirement of two users having the same recording software.

FIG. 6 shows one example of a schematic diagram illustrating a client device 605 (e.g., client device 105). Client device 605 may include a computing device capable of sending or receiving signals, such as via a wired or wireless network. A client device 605 may, for example, include a desktop computer or a portable device, such as a cellular telephone, a smartphone, a display pager, a radio frequency (RF) device, an infrared (IR) device, a Personal Digital Assistant (PDA), a handheld computer, a tablet computer, a laptop computer, a digital camera, a set top box, a wearable computer, an integrated device combining various features, such as features of the foregoing devices, or the like.

The client device 605 may vary in terms of capabilities or features. The invention is intended to cover a wide range of potential variations. For example, a cell phone may include a numeric keypad or a display of limited functionality, such as a monochrome liquid crystal display (LCD) for displaying text, pictures, etc. In contrast, however, as another example, a web-enabled client device may include one or more physical or virtual keyboards, mass storage, one or more accelerometers, one or more gyroscopes, global positioning system (GPS) or other location-identifying type capability, of a display with a high degree of functionality, such as a touch-sensitive color 2D or 3D display, for example.

The client device 605 may also include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook®, LinkedIn®, Twitter®, Flickr®, or Google+®, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sports leagues).

As shown in the example of FIG. 6, client device 605 may include one or more processing units (also referred to herein as CPUs) 622, which interface with at least one computer bus 625. A memory 630 can be persistent storage and interfaces with the computer bus 625. The memory 630 includes RAM 632 and ROM 634. ROM 634 includes a BIOS 640. Memory 630 interfaces with computer bus 625 so as to provide information stored in memory 630 to CPU 622 during execution of software programs such as an operating system 641, application programs 642, device drivers, and software modules 643, 645 that comprise program code, and/or computer-executable process steps, incorporating functionality described herein, e.g., one or more of process flows described herein. CPU 622 first loads computer-executable process steps from storage, e.g., memory 632, data storage medium/media 644, removable media drive, and/or other storage device. CPU 622 can then execute the stored process steps in order to execute the loaded computer-executable process steps. Stored data, e.g., data stored by a storage device, can be accessed by CPU 622 during the execution of computer-executable process steps.

Persistent storage medium/media 644 is a computer readable storage medium(s) that can be used to store software and data, e.g., an operating system and one or more application programs. Persistent storage medium/media 644 can also be used to store device drivers, such as one or more of a digital camera driver, monitor driver, printer driver, scanner driver, or other device drivers, web pages, content files, playlists and other files. Persistent storage medium/media 644 can further include program modules and data files used to implement one or more embodiments of the present disclosure.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Client device 605 can also include one or more of a power supply 626, network interface 650, audio interface 652, a display 654 (e.g., a monitor or screen), keypad 656, illuminator 658, I/O interface 660, a haptic interface 662, a GPS 664, a microphone 667, a video camera, TV/radio tuner, audio/video capture card, sound card, analog audio input with A/D converter, modem, digital media input (HDMI, optical link), digital I/O ports (RS-232, USB, FireWire, Thunderbolt), expansion slots (PCMCIA, ExpressCard, PCI, PCIe).

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

FIG. 7 is a block diagram illustrating an internal architecture of an example of a computer, such as server 110 and/or client device 105, 125 in accordance with one or more embodiments of the present disclosure. A computer as referred to herein refers to any device with a processor capable of executing logic or coded instructions, and could be a server, personal computer, set top box, tablet, smartphone, pad computer or media device, to name a few such devices. As shown in the example of FIG. 7, internal architecture 700 includes one or more processing units (also referred to herein as CPUs) 712, which interface with at least one computer bus 702. Also interfacing with computer bus 702 are persistent storage medium/media 706, network interface 714, memory 704, e.g., random access memory (RAM), run-time transient memory, read only memory (ROM), etc., media disk drive interface 708 as an interface for a drive that can read and/or write to media including removable media such as floppy, CD-ROM, DVD, etc. media, display interface 710 as interface for a monitor or other display device, keyboard interface 716 as interface for a keyboard, pointing device interface 718 as an interface for a mouse or other pointing device, and miscellaneous other interfaces (e.g., interfaces 720 and/or 722), such as parallel and serial port interfaces, a universal serial bus (USB) interface, and the like.

Memory 704 interfaces with computer bus 702 so as to provide information stored in memory 704 to CPU 712 during execution of software programs such as an operating system, application programs, device drivers, and software modules that comprise program code, and/or computer-executable process steps, incorporating functionality described herein, e.g., one or more of process flows described herein. CPU 712 first loads computer-executable process steps from storage, e.g., memory 704, storage medium/media 706, removable media drive, and/or other storage device. CPU 712 can then execute the stored process steps in order to execute the loaded computer-executable process steps. Stored data, e.g., data stored by a storage device, can be accessed by CPU 712 during the execution of computer-executable process steps.

As described above, persistent storage medium/media 706 is a computer readable storage medium(s) that can be used to store software and data, e.g., an operating system and one or more application programs. Persistent storage medium/media 706 can also be used to store device drivers, such as one or more of a digital camera driver, monitor driver, printer driver, scanner driver, or other device drivers, web pages, content files, playlists and other files. Persistent storage medium/media 706 can further include program modules and data files used to implement one or more embodiments of the present disclosure.

Internal architecture 700 of the computer can include (as stated above), a microphone, video camera, TV/radio tuner, audio/video capture card, sound card, analog audio input with A/D converter, modem, digital media input (HDMI, optical link), digital I/O ports (RS232, USB, FireWire, Thunderbolt), and/or expansion slots (PCMCIA, ExpressCard, PCI, PCIe).

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the user computing device or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the invention covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A method comprising:
providing, by a processor, at least one music collaboration software module to a first user and a second user, the at least one music collaboration software module provided to the first user being configured to work in conjunction with a first recording software module, and the at least one music collaboration software module provided to the second user being configured to work in conjunction with a second recording software module,
wherein the music collaboration software module is configured to enable the first user to collaborate in real time with the second user over a network, and
wherein the first recording software module is different than the second recording software module.

2. The method of claim 1, wherein the providing of the at least one music collaboration software module further comprises facilitating downloading of the at least one music collaboration software module to the first user and the second user.

3. The method of claim 1, wherein the at least one music collaboration software module enables the first user to record a first track using the first recording software module and the second user to record a second track using the second recording software module.

4. The method of claim 3, wherein the at least one music collaboration software module merges the first track and the second track into a single music recording.

5. The method of claim 1, further comprising enabling the at least one music collaboration software module to establish communications between the first user and the second user via a social networking platform or an instant messaging service.

6. The method of claim 1, further comprising enabling the first user and the second user to upload or download music tracks to or from the cloud.

7. The method of claim 1, wherein the music collaboration software module is configured to enable the first user to collaborate in real time with the second user via one or more of voice, video, and streaming.

8. The method of claim 1, further comprising displaying, to the first user, a choice of what the first user will be alerted to.

9. A computing device comprising:
a processor;
a storage medium for tangibly storing thereon program logic for execution by the processor, the program logic comprising:
providing logic executed by the processor for providing at least one music collaboration software module to a first user and a second user, the at least one music collaboration software module provided to the first user being configured to work in conjunction with a first recording software module, and the at least one music collaboration software module provided to the second user being configured to work in conjunction with a second recording software module,
wherein the music collaboration software module is configured to enable the first user to collaborate in real time with the second user over a network, and
wherein the first recording software module is different than the second recording software module.

10. The computing device of claim 9, wherein the providing logic for providing the at least one music collaboration software module further comprises facilitating logic for facilitating downloading of the at least one music collaboration software module to the first user and the second user.

11. The computing device of claim 9, wherein the at least one music collaboration software module enables the first user to record a first track using the first recording software module and the second user to record a second track using the second recording software module.

12. The computing device of claim 11, wherein the at least one music collaboration software module merges the first track and the second track into a single music recording.

13. The computing device of claim 9, further comprising social network communication logic executed by the processor for enabling the at least one music collaboration software module to establish communications between the first user and the second user via a social networking platform or an instant messaging service.

14. The computing device of claim 9, further comprising cloud communicating logic executed by the processor for enabling the first user and the second user to upload or download music tracks to or from the cloud.

15. The computing device of claim 9, wherein the music collaboration software module is configured to enable the first user to collaborate in real time with the second user via one or more of voice, video, and streaming.

16. The computing device of claim 9, further comprising displaying logic executed by the processor for displaying, to the first user, a choice of what the first user will be alerted to.

17. A non-transitory computer readable storage medium tangibly storing computer program instructions capable of being executed by a computer processor, the computer program instructions defining the steps of:
providing, by the computer processor, at least one music collaboration software module to a first user and a second user, the at least one music collaboration software module provided to the first user being configured to work in conjunction with a first recording software module, and the at least one music collaboration software module provided to the second user being configured to work in conjunction with a second recording software module,
wherein the music collaboration software module is configured to enable the first user to collaborate in real time with the second user over a network, and
wherein the first recording software module is different than the second recording software module.

18. The non-transitory computer readable storage medium of claim 17, wherein the providing of the at least one music collaboration software module further comprises facilitating downloading of the at least one music collaboration software module to the first user and the second user.

19. The non-transitory computer readable storage medium of claim 17, wherein the at least one music collaboration software module enables the first user to record a first track using the first recording software module and the second user to record a second track using the second recording software module.

20. The non-transitory computer readable storage medium of claim 19, wherein the at least one music collaboration software module merges the first track and the second track into a single music recording.
